(19) United States
(12) Patent Application Publication
(10) Pub. No.: US 2019/0242454 A1
(43) Pub. Date: Aug. 8, 2019

(54) VIBRATION-DAMPING DEVICE

(71) Applicants: YAMASHITA RUBBER CO., LTD., Fujimino-city, Saitama (JP); HONDA MOTOR CO., LTD., Tokyo (JP)

(72) Inventors: Yuichi Nakamaru, Saitama (JP); Kazumi Mikami, Saitama (JP)

(21) Appl. No.: 16/340,880

(22) PCT Filed: Oct. 12, 2017
(86) PCT No.: PCT/JP2017/037088

§ 371 Date: Apr. 10, 2019

(30) Foreign Application Priority Data
Oct. 12, 2016 (JP) 2016-201037

(51) Int. Cl. F16F 15/08; F16F 1/38

(52) U.S. Cl. CPC F16F 15/08; F16F 1/38

(57) ABSTRACT

A vibration-damping device includes an inner cylinder, a resin outer cylinder that is arranged on a radially outer side of the inner cylinder, and a rubber elastic body that couples the inner cylinder and the outer cylinder to each other. The outer cylinder includes: a press-insertion portion that is press-inserted into an insertion hole formed in an attachment member; and a tapered portion that is contiguous with the press-insertion portion and extends in a direction in which the press-insertion part is inserted into the attachment member. The tapered portion has a tapered shape having a decreasing diameter in the press-insertion direction. An outer surface of the tapered portion is formed to be parallel to a tapered guide surface provided on an insertion opening of the insertion hole of the attachment member.

### TECHNICAL FIELD

The present invention relates to a vibration-damping device having an inner cylinder and an outer cylinder with a rubber elastic body interposed therebetween.

### BACKGROUND ART

Conventionally, known examples of this kind of vibration-damping device include one that is incorporated into an engine mount or the like of an automobile. This vibration-damping device has an inner cylinder, an outer cylinder radially and outwardly spaced apart from the inner cylinder, a rubber elastic body elastically coupling the inner cylinder and the outer cylinder to each other.

Recently, adoption of resin materials for the vibration-damping device has been considered to reduce automobiles in weight. For example, the vibration-damping device described in Patent Literature 1 uses an outer cylinder made of a resin material.

The outer cylinder of the vibration-damping device of Patent Literature 1 is formed to have a constant inner diameter. The outer cylinder has a distal end portion whose outer periphery is chamfered such that the outer periphery inclines and has a decreasing diameter toward the distal end.

As the outer cylinder of the vibration-damping device of Patent Literature 1 is made of a resin material, the vibration-damping device can be reduced in weight, the cost of molds can be reduced, and improvement of the corrosion protection performance is expected. In addition, the distal end portion of the outer cylinder of the vibration-damping device of Patent Literature 1 is chamfered. This configuration facilitates press-inserting the vibration-damping device into an insertion hole of an attachment member.

### PRIOR ART DOCUMENT

### Patent Literature

Patent Literature 1: Japanese Patent Application Publication No. 2002-276714

### SUMMARY OF INVENTION

### Problems to be Solved by the Invention

However, as the outer cylinder of the vibration-damping device of Patent Literature 1 is formed to have a constant inner diameter, the outer cylinder could be damaged when the vibration-damping device is attached to the attachment member by being press-inserted into the insertion hole of the attachment member, because doing so may possibly create concentrated stress such that wrinkles are generated partially on the outer cylinder.

The present invention has been made to solve the above-described problem. An object of the present invention is to, while reducing the weight of the vibration-damping device, provide a vibration-damping device whose outer cylinder can be preferably prevented from being damaged when attaching the vibration-damping device to an attachment member.

### Solution to Problems

To solve such problem, a vibration-damping device of the present invention includes: an inner cylinder; an outer cylinder made of a resin material and arranged on an radially outer side of the inner cylinder; and a rubber elastic body coupling the inner cylinder and the outer cylinder to each other. The outer cylinder includes: a press-insertion portion to be press-inserted into an insertion hole formed on an attachment member; and a tapered portion that contiguously extends from the press-insertion portion in a press-insertion direction in which the press-insertion portion is inserted into the attachment member. The tapered portion has a tapered shape having a decreasing diameter in the press-insertion direction. The insertion hole of the attachment member has an insertion opening provided with a guide surface having a tapered shape, and the tapered portion has an outer surface which is in parallel with the guide surface.

With the vibration-damping device thus structured, the outer surface of the tapered portion of the outer cylinder comes in face-to-face contact with the guide surface of the attachment member while keeping parallel to the guide surface in the process of press-inserting the press-insertion portion of the outer cylinder into the insertion hole of the attachment member. That is, the outer surface of the tapered portion is prevented from being in line contact with the guide surface in the process of press-insertion. As a result, the outer surface of the tapered portion smoothly passes the guide surface, and, after that, the outer surface of the outer cylinder is press-inserted into the insertion hole to be in contact with the inner surface of the insertion hole of the attachment member.

Herein, the “face-to-face contact” means a state where the outer surface of the tapered portion of the outer cylinder and the guide surface of the attachment member are in planar contact with each other.

Herein, the “line contact” means a state where the outer surface of the tapered portion of the outer cylinder and the guide surface of the attachment member are partially in contact with each other on a line and are not in planar contact with each other.

The outer cylinder of the above-described vibration-damping device has a cylinder portion that extends from a small-diameter side end of the tapered portion in the press-insertion direction. Even with this structure, the outer surface of the tapered portion of the outer cylinder comes in face-to-face contact with the guide surface of the attachment member while keeping parallel to the guide surface in the process of press-inserting the press-insertion portion of the outer cylinder into the insertion hole of the attachment member. That is, the outer surface of the tapered portion is prevented from being in line contact with the guide surface in the process of press-insertion. As a result, the outer surface of the tapered portion smoothly passes the guide surface, and, after that, the outer surface of the outer cylinder is press-inserted into the insertion hole to be in contact with the inner surface of the insertion hole of the attachment member.

### Advantageous Effects of the Invention

The present invention provides a vibration-damping device whose outer cylinder can be preferably prevented from being damaged when attaching the vibration-damping device to the attachment member, while reducing the weight of the vibration-damping device.

### BRIEF DESCRIPTION OF DRAWINGS

FIG. 1 is a perspective view showing a vibration-damping device according to an embodiment of the present invention.

FIG. 2 is a vertical cross-sectional view of the vibration-damping device.

FIG. 3 is a diagram showing an outer cylinder of the vibration-damping device. FIG. 3(a) is a plan view of the outer cylinder, and FIG. 3(b) is a front view of the outer cylinder.

FIG. 4 is a diagram showing the outer cylinder of the vibration-damping device. FIG. 4(a) is a perspective view of the outer cylinder, and FIG. 4(b) is a vertical cross-sectional view of the outer cylinder.

FIGS. 5(a) to 5(c) are enlarged cross-sectional views showing an essential aspect of how the vibration-damping device is attached to the attachment member.

FIG. 6 is a vertical cross-sectional view of the vibration-damping device in a state where the vibration-damping device has been attached to the attachment member.

### DESCRIPTION OF EMBODIMENTS

Hereinafter, a vibration-damping device according to an embodiment of the present invention is described with reference to the drawings as appropriate.

A vibration-damping device 10 according to the present embodiment is disposed between a not-shown vibration source side (engine or the like) and a not-shown vehicle body side (frame or the like) provided to an automobile.

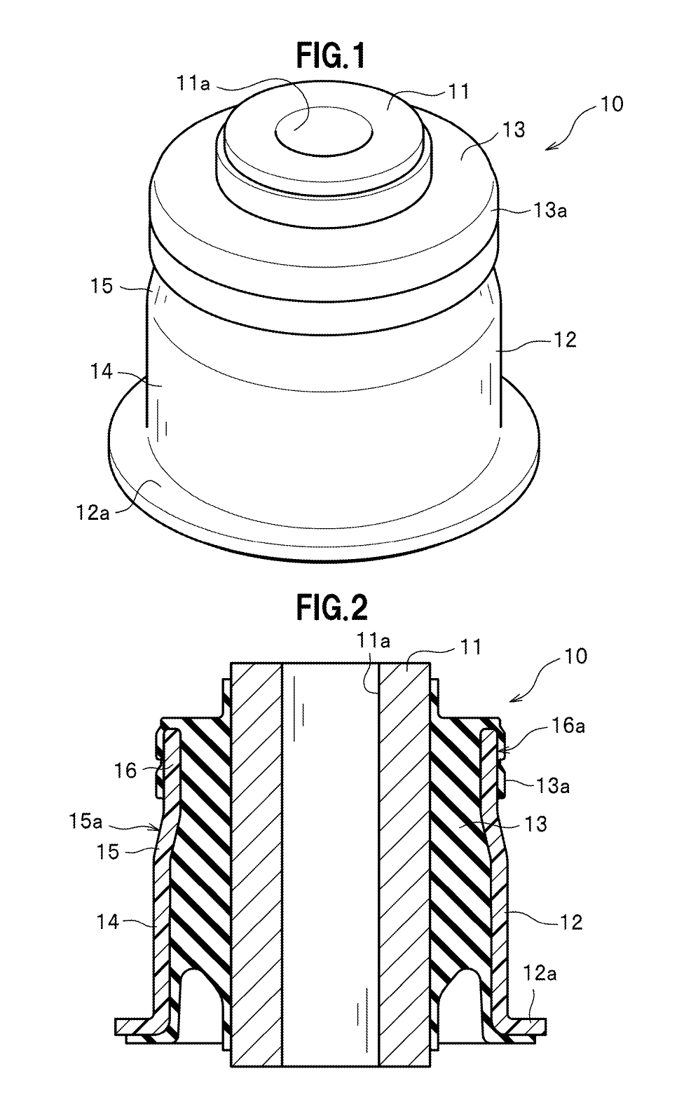

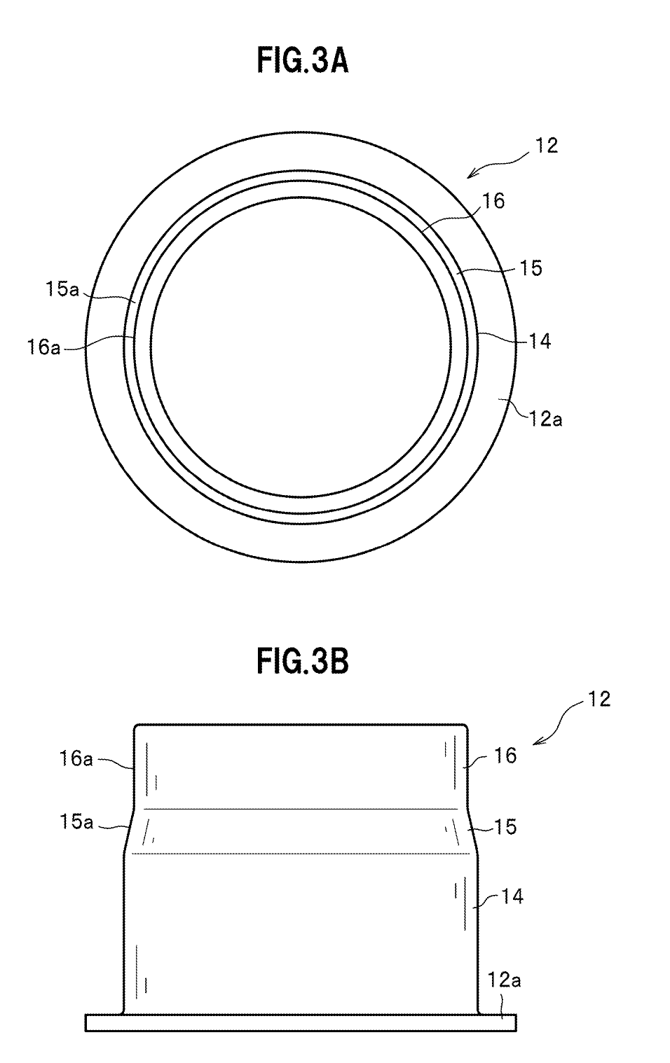

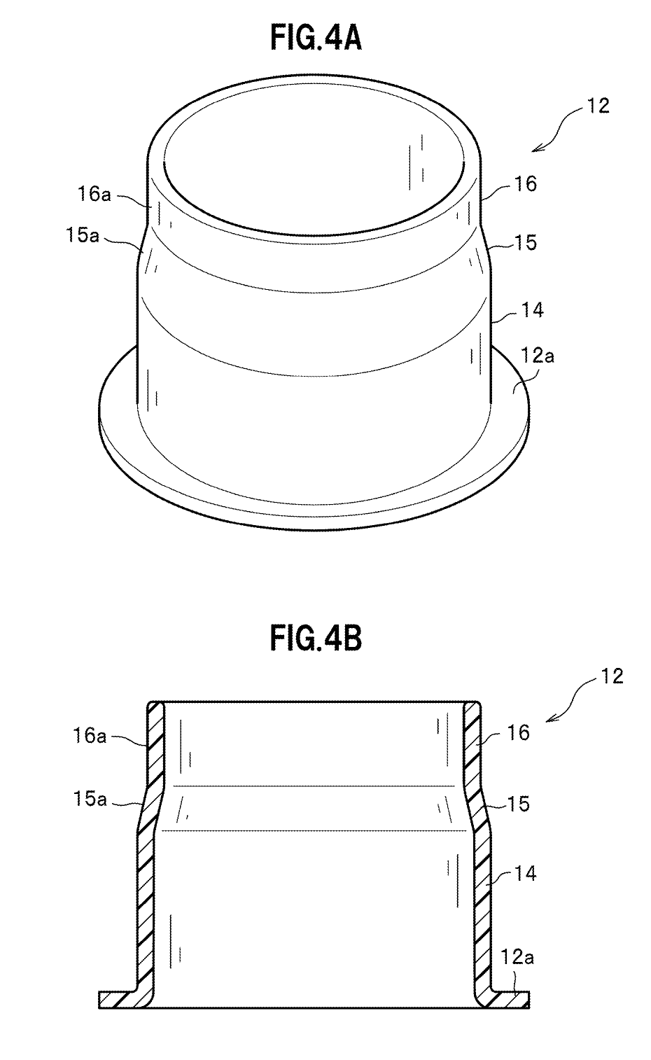

As shown in FIG. 1, the vibration-damping device 10 is structured to have an inner cylinder 11, an outer cylinder 12, and a rubber elastic body 13.

The inner cylinder 11 is a metal circular cylindrical member having a predetermined thickness. The inner cylinder 11 is located in a central portion of the vibration-damping device 10. The inner cylinder 11 has a through-hole 11a formed extending along an axial direction. The inner cylinder 11 has an external dimension which is constant from one end to the other end in the axial direction. The axial dimension of the inner cylinder 11 is larger than the axial dimension of the outer cylinder 12. As shown in FIG. 2, the inner cylinder 11 has opposite ends protruding from opposite ends of the outer cylinder 12. The inner cylinder 11 is fixed to the vehicle body side (frame or the like) with a not-shown bolt inserted through the through-hole 11a.

The outer cylinder 12 is a circular cylindrical member made of a resin material and having a smaller thickness than the inner cylinder 11. The outer cylinder 12 is, for example, an injection-molded product formed by injection molding. The outer cylinder 12 is radially and outwardly spaced apart from the inner cylinder 11 and forms an external shell of the vibration-damping device 10. The outer cylinder 12 has a large-diameter portion 14, a tapered portion 15 formed contiguously from an end of the large-diameter portion 14, a small-diameter portion 16 formed as a cylinder portion extending contiguously from an end of the tapered portion 15.

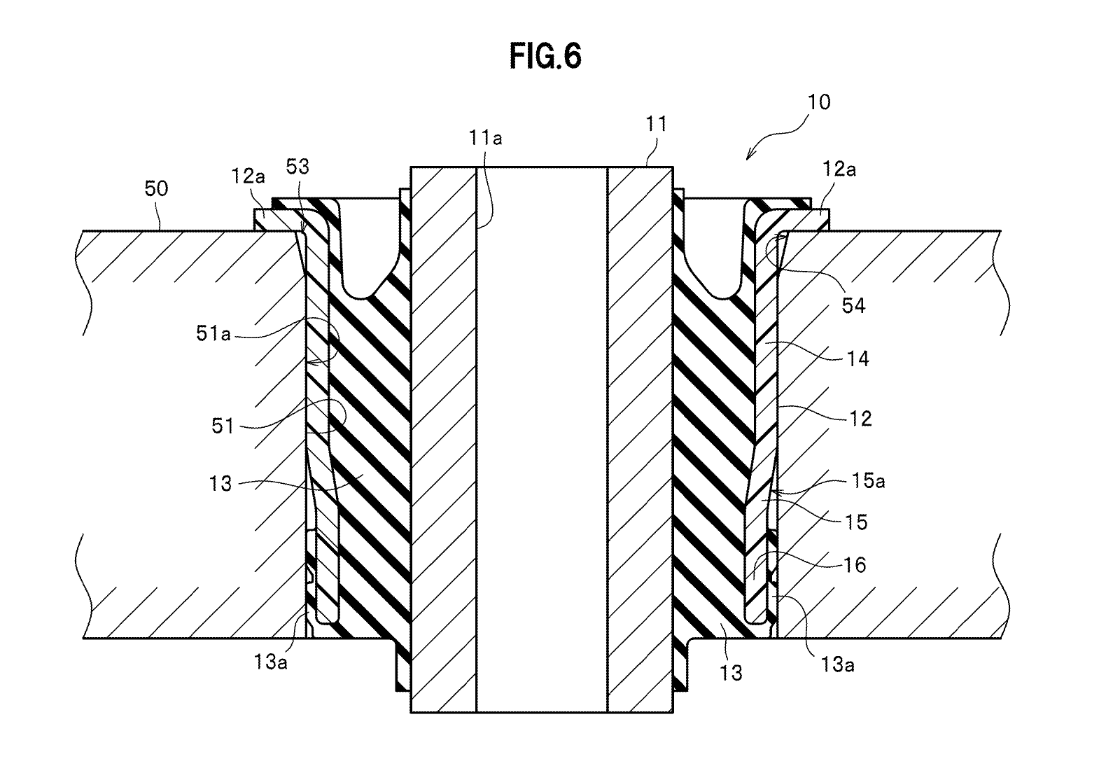

An attachment member 50 (holder) has an insertion hole 51. As shown in FIG. 6, this insertion hole 51 has an inner surface 51a with a circular cylindrical shape and a guide surface 54 having an increasing diameter toward an insertion opening 53, forming a tapered shape. The outer cylinder 12 of the vibration-damping device 10 is press-inserted to be in contact with the inner surface 51a. The guide surface 54 is formed on an inner edge portion of the insertion opening 53 of the insertion hole 51. The guide surface 54 guides the outer cylinder 12 toward the interior of the insertion hole 51 when the vibration-damping device 10 is press-inserted into the insertion hole 51.

The large-diameter portion 14 is to be press-inserted into the insertion hole 51 formed on the attachment member 50 (holder) and corresponding to the “press-insertion portion” described in the claims. The large-diameter portion 14 has an external dimension which is constant from one end to the other end in the axial direction. The tapered portion 15 is formed contiguously from the one end of the large-diameter portion 14. The large-diameter portion 14 has an integrally formed flange portion 12a projecting radially outward from an outer peripheral surface of the other end of the large-diameter portion 14.

The tapered portion 15 has a decreasing diameter toward one end in the axial direction, forming a tapered shape. The tapered portion 15 has an outer surface 15a inclining radially inward as shown in FIG. 2. The outer surface 15a of the tapered portion 15 is formed so as to be in parallel with the guide surface 54 of the insertion hole 51 of the attachment member 50 (holder). When the vibration-damping device 10 is press-inserted into the insertion hole 51 of the attachment member 50 (holder), the outer surface 15a of the tapered portion 15 faces the guide surface 54 of the insertion hole 51 and abuts the guide surface 54 while keeping parallel to the guide surface 54. The tapered portion 15 has one end from which the small-diameter portion 16 is contiguously formed.

The small-diameter portion 16 extends from the small-diameter portion side end of the tapered portion 15 toward an end of the small-diameter portion 16 and has a cylindrical shape. The small-diameter portion 16 has an outer diameter which is smaller than an outer diameter of the large-diameter portion 14 and smaller than an inner diameter of the insertion hole 51 of the attachment member 50 (holder). The outer dimension of the small-diameter portion 16 is constant over the whole length of the small-diameter portion 16.

An outer surface of the small-diameter portion 16 is covered by an extension portion 13a of the rubber elastic body 13, which extension portion 13a is formed to have a thin thickness. As shown in FIG. 6, thus structured small-diameter portion 16 comes in contact with the inner surface 51a insertion hole 51 of the attachment member 50 (holder) via the rubber elastic body 13.

As shown in FIG. 2, the rubber elastic body 13 is interposed between the inner cylinder 11 and the outer cylinder 12 and couples them elastically. For example, by injecting molten rubber between the inner cylinder 11 and the outer cylinder 12 set in a metal mould not shown and cooling down the injected rubber, the rubber elastic body 13 is vulcanized and bonded to an outer circumference surface of the inner cylinder 11 and an inner circumference surface of the outer cylinder 12. In addition, the injected molten rubber is also provided on the outer surface of the small-diameter portion 16 of the outer cylinder 12. In this way, an outer surface 16a of the small-diameter portion 16 of the outer cylinder 12 is covered by the extension portion 13a of the rubber elastic body 13.

Next, a description will be given of an operation that is caused when the vibration-damping device 10 is attached to the attachment member 50 (holder), which is a member to be mounted.

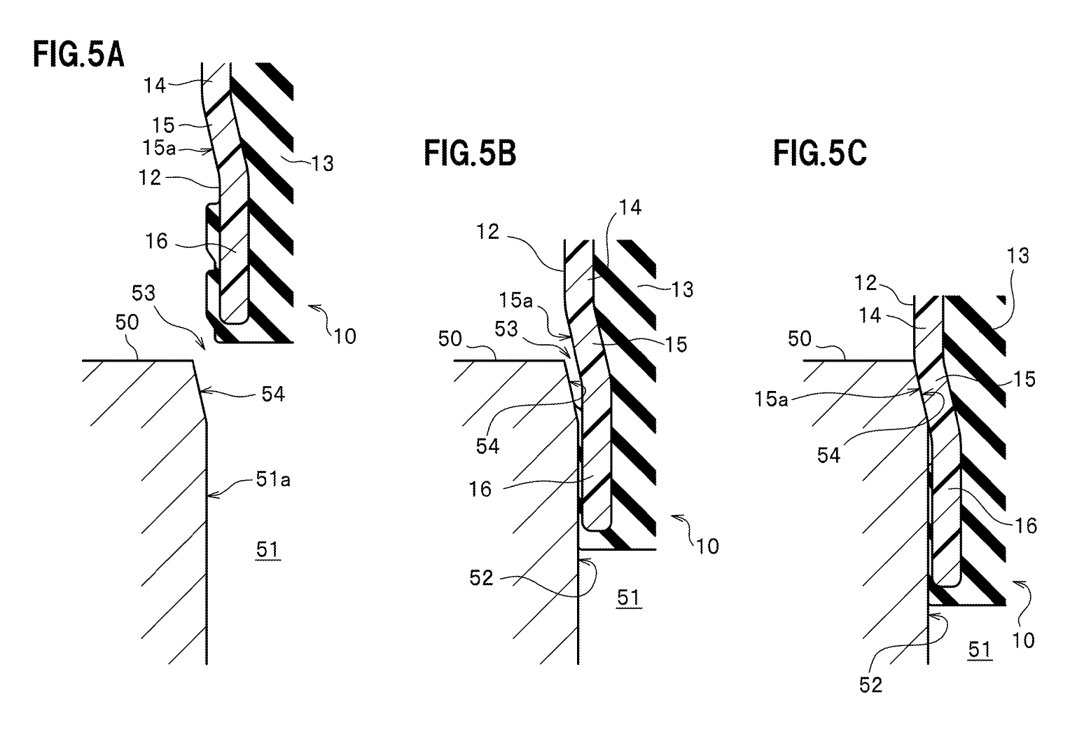

First, as shown in FIG. 5(a), the vibration-damping device 10 is brought close to the insertion opening 53 of the insertion hole of the attachment member 50 (holder) while directing the small-diameter portion 16, located on one end of the outer cylinder 12 of the vibration-damping device 10, to the insertion opening 53.

After that, the small-diameter portion 16 of the outer cylinder 12 is inserted via the insertion opening 53 into the insertion hole 51. In this process, as shown in FIG. 5(b), the outer surface 15a of the tapered portion 15 comes close to the guide surface 54 of the insertion hole 51, so that they face each other in parallel with a predetermined gap therebetween.

After that, when the outer cylinder 12 is further inserted into the insertion hole 51, the outer surface 15a of the tapered portion 15 abuts the guide surface 54 of the insertion hole 51 while keeping parallel to the guide surface 54 as shown in FIG. 5(c). In other words, the outer surface 15a of the tapered portion 15 comes in face-to-face contact with the guide surface 54 of the insertion hole 51 without inclining relative to the guide surface 54.

With this face-to-face contact, the outer surface 15a of the tapered portion 15 passes the guide surface 54 and moves to the inner surface 51a of the insertion hole 51. With this operation, the large-diameter portion 14 of the outer cylinder 12 is guided via the guide surface 54 to the inner surface 51a of the insertion hole 51 to be press-inserted into the insertion hole 51. As a result, the outer cylinder 15a is fixed to the attachment member 50 (holder) in a state where a force pressing the outer cylinder 15a radially inward is generated.

The extension portion 13a of the rubber elastic body 13, which covers the outer surface 16a of the small-diameter portion 16 of the outer cylinder 12, comes in contact with the inner surface 51a of the insertion hole 51 of the attachment member 50 (holder). With this structure, the sealing property of the outer cylinder 12 for the insertion hole 51 is ensured.

With the above-described vibration-damping device of the present embodiment, in the process of press-inserting the outer cylinder 12 into the insertion hole 51 of the attachment member 50 (holder), which is a member to be attached, the outer surface 15a of the tapered portion 15 of the outer cylinder 12 comes in face-to-face contact with the guide surface 54 of the insertion hole 51 while keeping parallel to the guide surface 54. That is, the outer surface 15a of the tapered portion 15 is prevented from coming in line contact with the guide surface 54 of the insertion hole 51 in the process of press-insertion. As a result, the outer surface 15a of the tapered portion 15 smoothly passes the guide surface 54 of the insertion hole 51, and, after that, the large-diameter portion 14 (outer surface) of the outer cylinder 12 is press-inserted into the insertion hole 51 to be in contact with the inner surface 51a.

Therefore, while reducing the weight of the vibration-damping device, the outer cylinder 12 of the vibration-damping device is preferably prevented from being damaged when the vibration-damping device is attached to the attachment member 50 (holder).

The outer cylinder 12 has the small-diameter portion 16 extending from the small-diameter side end of the tapered portion 15 in the direction for press-insertion. Also with this structure, in the process of press-inserting the outer cylinder 12 into the insertion hole 51 of the attachment member 50 (holder), which is a member to be attached, the outer surface 15a of the tapered portion 15 of the outer cylinder 12 comes in face-to-face contact with the guide surface 54 of the insertion hole 51 while keeping parallel to the guide surface 54. That is, the outer surface 15a of the tapered portion 15 is prevented from coming in line contact with the guide surface 54 of the insertion hole 51 in the process of press-insertion. As a result, the outer surface 15a of the tapered portion 15 smoothly passes the guide surface 54 of the insertion hole 51, and, after that, the large-diameter portion 14 (outer surface) of the outer cylinder 12 is press-inserted into the insertion hole 51 to be in contact with the inner surface 51a.

Therefore, while reducing the weight of the vibration-damping device, the outer cylinder 12 of the vibration-damping device is preferably prevented from being damaged when the vibration-damping device is attached to the attachment member 50 (holder).

Hereinabove, a description has been given of the embodiments of the present invention, but the present invention is not limited to the above-described embodiments and various modifications are possible.

For example, the inclination angle of the outer surface 15a of the tapered portion 15 can be selected as appropriate so long as the outer surface 15a is formed in parallel with the guide surface 54 of the insertion hole 51 of the attachment member 50 (holder).

In addition, the small-diameter portion 16 of the outer cylinder 12 is not necessarily provided. Even in this case, by forming the outer surface 15a of the tapered portion 15 to be in parallel with the guide surface 54 of the insertion hole 51 of the attachment member 50 (holder), the outer cylinder 12 is preferably prevented from being damaged when the vibration-damping device is attached to the attachment member 50 (holder).

In addition, the vibration-damping device may be such that at least a portion of the outer surface 16a of the small-diameter portion 16 is covered by the extension portion 13a of the rubber elastic body 13.

The present invention is not limited to those whose vibration source is an engine, and can be widely applied to vehicles whose vibration source is a motor.

### REFERENCE SIGNS LIST

10 vibration-damping device
11 inner cylinder
12 outer cylinder
13 rubber elastic body
13a extension portion
15 tapered portion
15a outer surface of tapered portion
16 small-diameter portion (cylinder portion)
16a outer surface of small-diameter portion
50 attachment member (holder)
51 insertion hole
51a inner surface
53 insertion opening
54 guide surface

What is claimed is:

1. A vibration-damping device comprising:
an inner cylinder;
an outer cylinder made of a resin material and arranged on a radially outer side of the inner cylinder; and
a rubber elastic body coupling the inner cylinder and the outer cylinder to each other,
wherein the outer cylinder comprises:
a press-insertion portion to be press-inserted into an insertion hole formed on an attachment member; and
a tapered portion that contiguously extends from the press-insertion portion in a press-insertion direction in which the press-insertion portion is inserted into the attachment member,
wherein the tapered portion has a tapered shape having a decreasing diameter in the press-insertion direction, and
wherein the insertion hole of the attachment member has an insertion opening provided with a guide surface having a tapered shape, and the tapered portion has an outer surface which is in parallel with the guide surface.

2. The vibration-damping device according to claim 1,
wherein the outer cylinder has a cylinder portion that extends from a small-diameter side end of the tapered portion in the press-insertion direction.
